(19) United States
(12) Patent Application Publication
(10) Pub. No.: US 2024/0070362 A1
(43) Pub. Date: Feb. 29, 2024

(54) METHOD AND DEVICE FOR SIMULATING PERFORMANCE OF SEMICONDUCTOR DEVICE, AND SYSTEM AND METHOD FOR EVALUATING PERFORMANCE OF SEMICONDUCTOR DEVICE

(71) Applicant: Samsung Electronics Co., Ltd., Suwon-si (KR)

(72) Inventor: Sung-Min HONG, Gwangju-si (KR)

(73) Assignees: Samsung Electronics Co., Ltd., Suwon-si (KR); GWANGJU INSTITUTE OF SCIENCE AND TECHNOLOGY, Gwangju (KR)

(21) Appl. No.: 18/319,684

(22) Filed: May 18, 2023

(30) Foreign Application Priority Data
Aug. 30, 2022 (KR) 10-22-0109496
Oct. 19, 2022 (KR) 10-2022-0135231

(51) Int. Cl. G06F 30/367

(52) U.S. Cl. CPC G06F 30/367; G06F 2111/10

(57) ABSTRACT

A simulation method includes establishing a carrier distribution function of a semiconductor device model, computing one or more values corresponding to a solution of an approximate Boltzmann transport equation with respect to the carrier distribution function, and outputting a performance value of the semiconductor device model, which corresponds to the one or more values corresponding to the solution of the approximate Boltzmann transport equation, as a simulation result value.

### CROSS-REFERENCE TO RELATED APPLICATION

This application is based on and claims priority under 35 U.S.C. § 119 to Korean Patent Application Nos. 10-2022-0109496, filed on Aug. 30, 2022, and 10-2022-0135231, filed on Oct. 19, 2022, in the Korean Intellectual Property Office, the disclosure of each of which is incorporated by reference herein in their entirety.

### BACKGROUND

Various example embodiments relate to an electronic device, and more particularly, to a simulation method and/or a simulation device for simulating the performance of a designed or newly designed semiconductor device, and/or a performance evaluation system and/or a performance evaluation method for evaluating the performance of a newly designed semiconductor device.

Semiconductor device simulation is a technique of predicting performance of a semiconductor device by using a computer program. To save time and/or costs in a semiconductor device development process, semiconductor device simulation is often necessarily or desirably performed.

In semiconductor device simulation, the performance of a semiconductor device may be predicted based on the movement or mobility of electrons/holes e.g., carriers) inside the semiconductor device, and various simulation methods may be performed according to a level at which the movement of the carriers can be handled.

### SUMMARY

Various example embodiments provide one or more of a method, a device, and a system capable of stably or more stably performing a numerical analysis on a semiconductor device even when a potential of carriers in the semiconductor device varies with time.

According various example embodiments, there is provided a method of simulating performance of a semiconductor device model, the method including establishing a carrier distribution function of the semiconductor device model, which indicates a distribution of carriers having a state of having particular energy at a particular position in a real space, computing one or more values corresponding to a solution of an approximate Boltzmann transport equation, as [Equation 1] below, with respect to the carrier distribution function,

$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} , \qquad [ Equation 1 ]$$

where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for the real space and total energy, f_{l′} denotes the carrier distribution function, ∂/∂t denotes a time differential, and S denotes a scattering term related to scattering of the carriers, and outputting a performance value of the semiconductor device model, which corresponds to the one or more values associated with the solution of the approximate Boltzmann transport equation, as a simulation result value.

Alternatively or additionally, according to various example embodiments, there is provided a device for simulating the performance of a semiconductor device model, the device including a memory configured to store code data indicating an approximate Boltzmann transport equation and characteristics data indicating characteristics of a semiconductor device model, and a processor configured to simulate performance of the semiconductor device model, based on the code data and the characteristic data, and output a performance value of the semiconductor device model as a simulation result value, wherein the processor is further configured to establish a carrier distribution function of the semiconductor device model, which indicates a distribution of carriers having a state of having particular energy at a particular position in a real space, compute one or more values corresponding to a solution of an approximate Boltzmann transport equation, as [Equation 1] below, with respect to the carrier distribution function,

$${\sum }_{l ′} \frac{\partial }{\partial r} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + V \cdot [ {A}_{l , l ′} {f}_{l ′} ] - {B}_{l , l ′} {f}_{l ′} = {S}_{l} ,$$

where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for the real space and total energy, f_{l′}, denotes the carrier distribution function, ∂/∂t denotes a time differential, and S denotes a scattering term related to scattering of the carriers, and process the performance value of the semiconductor device model, based on the one or more values associated with the solution of the approximate Boltzmann transport equation.

Alternatively or additionally, according various example embodiments, there is provided a system for evaluating performance of a semiconductor device, the system including the semiconductor device, a measurement device configured to measure characteristics of the semiconductor device, and a simulation device configured to simulate performance of a semiconductor device model corresponding to the semiconductor device. The simulation device includes a processor configured to execute machine-readable instructions that, when executed by the processor, cause the simulation device to compute a value corresponding to a solution of an approximate Boltzmann transport equation, based on code data indicating the approximate Boltzmann transport equation and characteristics data indicating characteristics of a semiconductor device model, generate a performance value of the semiconductor device model, which corresponds to the solution of the approximate Boltzmann transport equation, as a simulation result value, and output an evaluation value obtained by evaluating the performance of the semiconductor device, based on the simulation result value and a measurement value provided from the measurement device, and the approximate Boltzmann transport equation is [Equation 1] below,

$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} , \qquad [ Equation 1 ]$$

where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for a real space and total energy, f_{l′} denotes a carrier distribution function indicating a distribution of carriers having a state of having particular energy at a particular position in the real space, ∂/∂t denotes a time differential, and S denotes a scattering term related to scattering of the carriers.

Alternatively or additionally, according to various example embodiments, there is provided a method of evaluating performance of a semiconductor device, the method including receiving characteristic information indicating a characteristic value of the semiconductor device, simulating the performance of a semiconductor device model constructed according to the characteristic information, based on an approximate Boltzmann transport equation, receiving measurement information indicating a measurement value obtained by measuring characteristics of the semiconductor device, and outputting evaluation information obtained by evaluating the performance of the semiconductor device, based on a simulation result value and the measurement value, wherein the approximate Boltzmann transport equation is represented by [Equation 1] below,

$${\sum }_{{l}^{′}} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} , \qquad [ Equation 1 ]$$

where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for a real space and total energy, f_{l′} denotes a carrier distribution function, ∂/∂t denotes a time differential, and S denotes a scattering term related to scattering of carriers.

According to various example embodiments, there is provided a computer program stored in a computer-readable recording medium to execute the methods described above.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a performance evaluation system according to some example embodiments;

FIG. 2 is a block diagram illustrating a simulation device according to some example embodiments;

FIG. 3 is a flowchart illustrating a performance evaluation method according to some example embodiments;

FIG. 4 is a flowchart illustrating a simulation method according to some example embodiments;

FIG. 5 is a flowchart particularly illustrating a simulation method according to some example embodiments;

FIG. 6 is a flowchart illustrating a method of establishing an approximate Boltzmann transport equation according to some example embodiments;

FIG. 7 is a graph illustrating a carrier distribution function distributed according to continuous total energy;

FIG. 8 is a graph illustrating a carrier distribution function distributed according to discretized total energy;

FIG. 9 is a graph illustrating a simulation result value computed based on the Boltzmann transport equation to which kinetic energy is applied; and

FIG. 10 is a graph illustrating a simulation result value computed based on an approximate Boltzmann transport equation to which discretized total energy is applied.

### DETAILED DESCRIPTION OF VARIOUS EXAMPLE EMBODIMENTS

Hereinafter, embodiments are described in detail with reference to the accompanying drawings.

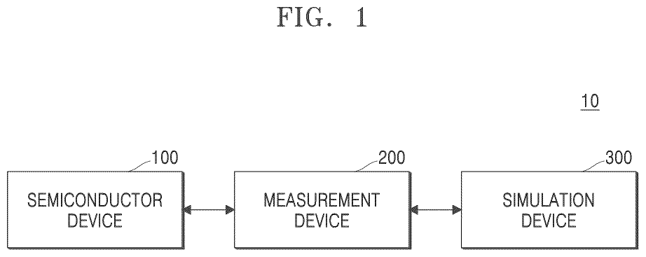

FIG. 1 is a block diagram illustrating a performance evaluation system 10 according to some example embodiments.

The performance evaluation system 10 may be or may include or be included in a system configured to test the performance of a semiconductor device 100 newly developed. The performance evaluation system 10 may include the semiconductor device 100, a measurement device 200, and a simulation device 300.

The semiconductor device 100 may be or may include a device developed, e.g. newly developed by a designer. The semiconductor device 100 may have various characteristics. Herein, the characteristics of the semiconductor device 100 may include one or more physical characteristics, one or more electrical characteristics, and/or the like. The physical characteristics may include, for example, one or more of a size, such as one or more of a width, a thickness, a length, and an area, of the semiconductor device 100, a length of a channel included in the semiconductor device 100, one or more materials included in the semiconductor device 100, and the like. The electrical characteristics may include, for example, one or more of a direct current (DC) current, a transient response characteristic, a threshold voltage, a carrier velocity, a carrier density, and the like.

The measurement device 200 may measure the characteristics of the semiconductor device 100. In some example embodiments, the measurement device 200 may measure the physical characteristics of the semiconductor device 100. In some example embodiments, the measurement device 200 may apply a supply voltage to the semiconductor device 100 and measure the electrical characteristics of the semiconductor device 100, e.g. while or after applying the supply voltage to the semiconductor device 100. The measurement device 200 may provide, to the simulation device 300, a measurement value obtained by measuring the characteristics of the semiconductor device 100.

Various devices capable of performing computation processing and providing a result, e.g. to a user and/or to other software, may be included in the simulation device 300 according to the inventive concept. For example, the simulation device 300 may include both or any one of a computer and a portable terminal.

The computer may be or may include, for example, one or more of a notebook computer with a web browser, a desktop computer, a laptop computer, a tablet personal computer (PC), a slate PC, and the like.

The portable terminal may include, as wireless communication devices guaranteeing portability and mobility, for example, all or any types of handheld-based wireless communication devices, such as one or more of a personal communication system (PCS) terminal, a global system for mobile communications (GSM) terminal, a personal digital cellular (PDC) terminal, a personal handy-phone system (PHS) terminal, a personal digital assistant (PDA) terminal, an international mobile telecommunication (IMT)-2000 terminal, a code division multiple access (CDMA)-2000 terminal, a wideband code division multiple access(WCDMA) terminal, a wireless broadband Internet (WiBro) terminal, and a smartphone, and wearable devices, such as one or more of a watch, a ring, a bracelet, glasses, and a head mounted device (HMD).

The simulation device 300 may simulate the performance of a semiconductor device model corresponding to the semiconductor device 100. The semiconductor device model is or includes or is included in a model on which the characteristics of the semiconductor device 100 are reflected, and may be implemented on a computer. For example, when software, and/or a user, and/or a designer, or the like inputs a characteristic value of the semiconductor device 100 to a computer, the semiconductor device model may be implemented in the computer (or a program stored in the computer) by the program (or various applications) stored in the computer. The simulation device 300 may store characteristics data indicating the characteristics of the semiconductor device model.

The simulation device 300 may establish a carrier distribution function of the semiconductor device model based on the characteristics data. The carrier distribution function may be or may include a function indicating a distribution of carriers having a state of having particular energy at a particular position in a real space. A carrier may be an electron and/or a hole and/or an electron-hole pair.

The simulation device 300 may compute a solution of, or a value corresponding to a solution of, an approximate Boltzmann transport equation with respect to the carrier distribution function based on code data indicating the approximate Boltzmann transport equation and the characteristics data indicating the characteristics of the semiconductor device model. The approximate Boltzmann transport equation may be or may correspond to a total energy-based Boltzmann transport equation. The total energy may include two or more types of energy. For example, the total energy may include kinetic energy of the carriers and a potential of the carriers. The potential of the carriers may be or correspond to electrical potential energy which the carriers have.

When the approximate Boltzmann transport equation is applied to a simulation operation of the simulation device 300, the simulation device 300 may, e.g. may accurately, represent a path along which the carriers move in a designated electric field. Accordingly, even when a potential changes with time, an energy space does not change, and there is no or a reduced diffusion phenomenon in the energy space according to a numerical analysis error, and thus, the simulation device 300 may more stably and/or more accurately simulate the performance of the semiconductor device model.

The simulation device 300 may calculate a performance value of the semiconductor device model, which corresponds to a solution of the approximate Boltzmann transport equation, by computing the solution of or a variable corresponding to a solution of the approximate Boltzmann transport equation. A performance value, e.g. a quality value, of the semiconductor device model may correspond to the characteristic value of the semiconductor device 100.

The simulation device 300 may generate and/or output the performance value of the semiconductor device model as a simulation result value. In addition, the simulation device 300 may output an evaluation value obtained by evaluating the performance of the semiconductor device 100 based on the simulation result value and the measurement value provided from the measurement device 200.

As described above, the performance evaluation system 10 may more stably and/or more accurately evaluate the performance of the semiconductor device model even when a potential of carriers changes with time, by using the approximate Boltzmann transport equation.

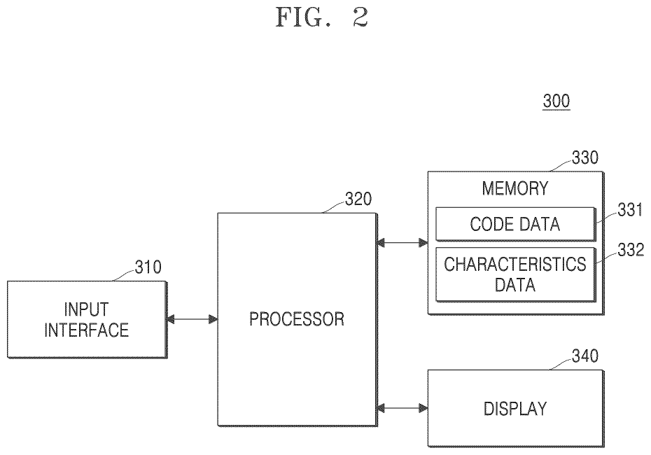

FIG. 2 is a block diagram illustrating the simulation device 300 according to some example embodiments.

Referring to FIG. 2, the simulation device 300 may include an input interface 310, a processor 320, a memory 330, and a display 340.

The input interface 310 may perform a role of a passage with various types of external devices connected to the simulation device 300. In some example embodiments, the input interface 310 may receive input information including an input value from a user or the like. The input information may include, for example, the characteristic value of the semiconductor device 100.

The input interface 310 may communicate with the processor 320. In some example embodiments, the input interface 310 may provide the input information received from the outside to the processor 320.

The input interface 310 may include at least one of a wired and/or wireless headset port, an external charger port, a wired and/or wireless data port, a memory card port, a port to which a device having a subscriber identification module (SIM) is connected, an audio input/output (I/O) port, a video I/O port, and an earphone port.

The processor 320 may process or control various functions performed by the simulation device 300. The processor 320 may control an operation of the input interface 310, an operation of the memory 330, and/or an operation of the display 340.

The processor 320 may control at least some of the components shown in FIG. 2, to drive an application program stored in the memory 330. Furthermore, the processor 320 may combine and operate at least two of the components included in the simulation device 300, to drive the application program.

The processor 320 may commonly control a general operation of the simulation device 300 besides an operation related to the application program. The processor 320 may provide appropriate information or function to the user or process the appropriate information or function, by processing one or more of a signal, data, information, or the like input or output through the components described above or driving an application program stored in the memory 330.

The processor 320 may load code data 331 and characteristics data 332 from the memory 330. The processor 320 may simulate the performance of the semiconductor device model based on the code data 331 and the characteristics data 332 and output a performance value of the semiconductor device model as a simulation result value. The processor 320 may configure the semiconductor device model by using the characteristics data 332. In addition, the processor 320 may establish the carrier distribution function of the semiconductor device model with respect to total energy. The processor 320 may obtain the approximate Boltzmann transport equation from the code data 331. The processor 320 may compute a solution of or a value or values based on a solution of the approximate Boltzmann transport equation with respect to the carrier distribution function.

In some example embodiments, the approximate Boltzmann transport equation may be represented by [Equation 1] below.

[Equation 1]

$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l}$$

In [Equation 1], l and l′ may be indexes according to a change from a momentum space to an energy space.

In [Equation 1], Δ or nabla may be a differential of a real space.

In [Equation 1], h may be discretized total energy. In some example embodiments, the discretized total energy h may include carrier kinetic energy ε and an approximated carrier potential \tilde{V} as in [Equation 2].

h=ε+\tilde{V} [Equation 2]

In some example embodiments, the approximate carrier potential \tilde{V} may be determined as or be based on a value closest to a potential set for the semiconductor device model.

In some example embodiments, the approximate carrier potential \tilde{V} may be determined as or be based on a value closest to the potential set for the semiconductor device model within a range such as a dynamically determined (or, alternatively, preset) range.

In some example embodiments, the range include discretized potentials. In this case, the approximated carrier potential \tilde{V} may be determined as a value or be based on a value closest to the potential set for the semiconductor device model among the discretized potentials included in the preset range.

In some example embodiments, a size of the range may be less than or equal to a reference size. For example, the less the size of the range is, the more linearly the approximate Boltzmann transport equation may be analyzed, and thus, the simulation device 300 may stably simulate the performance of the semiconductor device model.

In [Equation 1], F may be a force. In some example embodiments, the force F may be or may correspond to an electric force of a potential V set for the semiconductor device model, according to [Equation 3] below.

F=−Δ·V [Equation 3]

In this case, the approximated carrier potential \tilde{V} according to some example embodiments is determined as or be based on a value closest to the potential V set for the semiconductor device model, and thus, a value of the term (F+Δ\tilde{V}) in [Equation 1] may be very small. Alternatively or additionally, a value of the first term (e.g.,

$$( F + ∇ \tilde{V} ) \cdot \frac{\partial }{\partial h} [ {A}_{l , l ′} {f}_{l ′} ] )$$

in [Equation 1] may be small enough to be mathematically ignored. Alternatively or additionally in [Equation 1], a differential ∂/∂h of approximated total energy may be mathematically ignored, and a differential Δ of the real space may be mainly considered. Accordingly, the approximate Boltzmann transport equation may be more stably computed and/or analyzed.

In [Equation 1], A_{l,l′} and B_{l,l′} may be coefficients for the real space and the total energy, respectively. In some example embodiments, A_{l,l′} and B_{l,l′} may variably change according to the real space and the total energy (and/or the discretized total energy h).

In [Equation 1], f_{l′} may be the carrier distribution function. Z is a density of states. ∂/∂t denotes a time differential. S may be a scattering term related to scattering of carriers.

The processor 320 may process a performance value of the semiconductor device model based on a solution of the approximate Boltzmann transport equation.

The memory 330 may store code and/or data supporting various functions of the simulation device 300. The memory 330 may store a plurality of application programs or applications driven by the simulation device 300, data for an operation of the simulation device 300, and instructions. The memory 330 may be implemented by a memory.

The memory 330 may store the code data 331 and the characteristics data 332. The code data 331 may be data indicating code for implementing the approximate Boltzmann transport equation. The characteristics data 332 may be data indicating the characteristics of the semiconductor device model.

Although not shown in FIG. 2, the simulation device 300 may further include a communication processor or module configured to perform wired and/or wireless communication with an external device.

The wireless communication may include, for example, one or more of wireless local area network (WLAN) communication, wireless-fidelity (Wi-Fi) communication, Wi-Fi Direct communication, digital living network alliance (DLNA) communication, wireless broadband (WiBro) communication, world interoperability for microwave access (WiMAX) communication, high speed downlink packet access (HSDPA) communication, high speed uplink packet access (HSUPA) communication, long term evolution (LTE) communication, LTE-advanced (LTE-A) communication, or the like.

Short range communication may include, for example, one or more of Bluetooth™ communication, radio frequency identification (RFID) communication, infrared data association (IrDA) communication, ultra wideband (UWB) communication, ZigBee communication, near field communication (NFC) communication, Wi-Fi communication, Wi-Fi Direct communication, wireless universal serial bus (USB) communication, or the like.

As described above, the simulation device 300 may stably and accurately simulate the performance of the semiconductor device model even when a potential of carriers changes with time, by using the approximate Boltzmann transport equation.

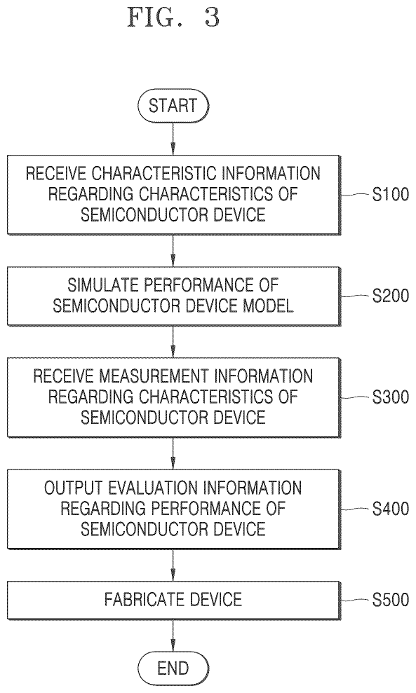

FIG. 3 is a flowchart illustrating a performance evaluation method according to some example embodiments.

Referring to FIG. 3, at least one or some or all of the performance evaluation method shown in FIG. 3 may be implemented on a computer. Alternatively or additionally, the performance evaluation method shown in FIG. 3 may be performed by the performance evaluation system 10 shown in FIG. 1.

In operation S100, characteristic information regarding the characteristics of a semiconductor device is received. Herein, the characteristic information may include, for example, a characteristic value of the semiconductor device. The characteristic information may be input by, for example, one or more of a computer, a user, a designer, or the like. For example, referring to FIG. 1, the simulation device 300 may receive characteristic information regarding the characteristics of the semiconductor device 100.

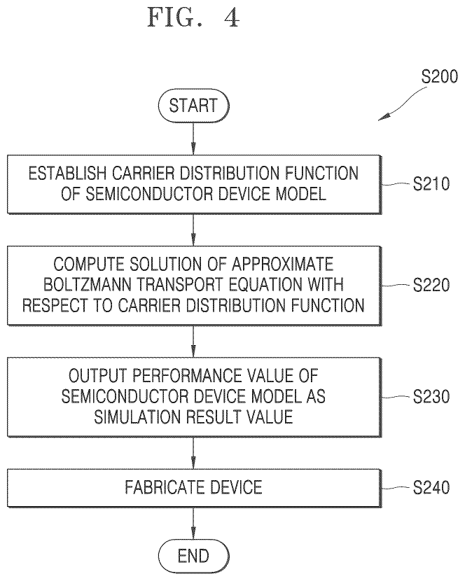

In operation S200, the performance of a semiconductor device model may be simulated. The semiconductor device model may be constructed on the computer according to the characteristic information received in operation S100. A detailed description of operation S200 is made below with reference to FIG. 4.

In operation S300, measurement information regarding the characteristics of the semiconductor device may be received. The measurement information regarding the characteristics of the semiconductor device may include a measurement value obtained by measuring the characteristics of the semiconductor device. The measurement information may be generated by the measurement device 200 shown in FIG. 1. For example, referring to FIG. 1, the measurement device 200 may measure the characteristics of the semiconductor device 100 and provide the measurement information to the simulation device 300. The simulation device 300 may receive the measurement information.

In operation S400, evaluation information regarding the performance of the semiconductor device is output. Particularly, in operation S400, evaluation information obtained by evaluating the performance of the semiconductor device based on a simulation result value and the measurement value is output. For example, referring to FIG. 1, the simulation device 300 may evaluate the performance of the semiconductor device 100 by determining a similarity between the simulation result value and the measurement value, e.g. a similarity measured according to a root-mean-square evaluation method. Alternatively or additionally, referring to FIG. 1, the simulation device 300 may evaluate the performance of the semiconductor device 100 by determining whether the simulation result value matches or is close to matching the measurement value.

The performance evaluation method shown in FIG. 3 may be implemented by a computer program stored in a computer-readable recording medium by being coupled to a computer that is hardware.

In operation S500, another semiconductor device may be fabricated. In some example embodiments the semiconductor device may be fabricated based on the evaluation of the simulation result.

As described above, the performance evaluation method may more stably and/or more accurately evaluate the performance of a semiconductor device model even when a potential of carriers varies with time.

FIG. 4 is a flowchart illustrating a simulation method according to some example embodiments.

Referring to FIG. 4, the simulation method shown in FIG. 4 may correspond to operation S200 shown in FIG. 3.

In operation S210, a carrier distribution function of a semiconductor device model is established. The carrier distribution function may be a function indicating a distribution of carriers having a state of having particular energy at a particular position in a real space.

In operation S220, a solution of or a value or values corresponding to a solution of an approximate Boltzmann transport equation with respect to the carrier distribution function is computed. The approximate Boltzmann transport equation may be represented by [Equation 1] described above. In some example embodiments, the discretized total energy h in the approximate Boltzmann transport equation may include the carrier kinetic energy ε and the approximated carrier potential \tilde{V} as in [Equation 2] described above. In some example embodiments, the force F in the approximate Boltzmann transport equation may be an electric force of the potential V set for the semiconductor device model as in [Equation 3] described above.

In operation S230, a performance value of the semiconductor device model is output as a simulation result value. For example, in operation S230 a performance value or performance metric or quality value of the semiconductor device model, which corresponds to a solution of the approximate Boltzmann transport equation, is output as a simulation result value.

In operation S240, a semiconductor device may be fabricated, e.g. may be fabricated based on the simulation result value.

In some example embodiments, the performance value of the semiconductor device model may include a dynamic parameter indicating a characteristic transient with time. For example, the performance value of the semiconductor device model may be a value indicating a transient response characteristic. However, the performance value of the semiconductor device model is not limited thereto.

In some example embodiments, the performance value of the semiconductor device model may include a static parameter indicating a characteristic independent to time. For example, the performance value of the semiconductor device model may be a DC current value. However, the performance value of the semiconductor device model is not limited thereto.

The simulation method or one or more processes included in the simulation method shown in FIG. 4 may be implemented by a computer program stored in a computer-readable recording medium by being coupled to a computer that is hardware.

As described above, the simulation method may more stably and/or more accurately evaluate the performance of a semiconductor device model even when a potential of carriers varies with time.

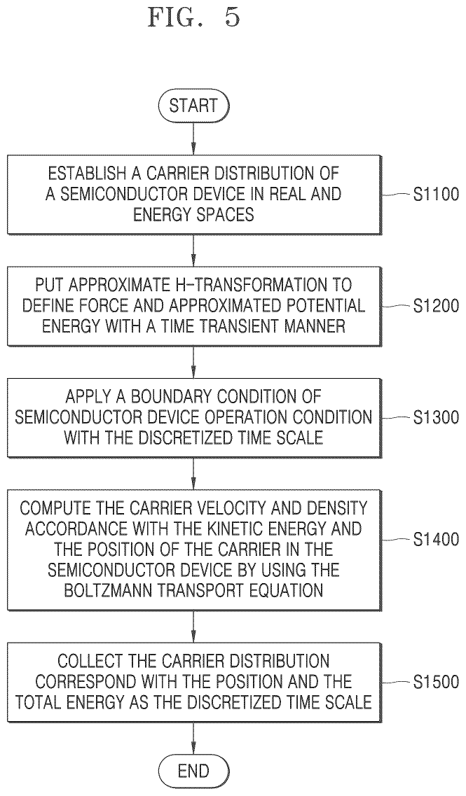

FIG. 5 is a flowchart particularly illustrating a simulation method according to some example embodiments.

Referring to FIG. 5, in operation S1100, the processor 320 may establish a carrier distribution of a semiconductor device in a real space and an energy space. Herein, the carrier distribution may be the carrier distribution function described above.

In operation S1200, approximate H-transformation is input to define a force and an approximated potential energy in a time-transient manner The H-transformation may be obtained by substituting an equation of total energy and an electric force for a kinetic energy-based Boltzmann transport equation. The kinetic energy-based Boltzmann transport equation is represented by [Equation 4] below.

$${\sum }_{l ′} \frac{\partial }{\partial t} [ {Z}_{l , {l}^{′}} {f}_{{l}^{′}} ] + \frac{\partial }{\partial ε} [ F \cdot {A}_{l , l ′} {f}_{l ′} ] + ∇ \cdot [ {A}_{l , l ′} {f}_{l ′} ] - {B}_{l , l ′} {f}_{l ′} = {S}_{l} \qquad [ Equation 4 ]$$

In addition, the total energy may include the carrier kinetic energy ε and the potential V set for the semiconductor device model as in [Equation 5] below.

H=ε+V [Equation 5]

The electric force is the same as [Equation 3] described above.

Based on [Equation 3] and [Equation 5], if a differential of the total energy H is substituted for a differential ∂/∂ε of the carrier kinetic energy ε in [Equation 4], [Equation 4] may be modified to [Equation 6] below.

[Equation 6]

$${\sum }_{l ′} \frac{\partial }{\partial t} [ {Z}_{l , {l}^{′}} {f}_{{l}^{′}} ] + ∇ \cdot [ {A}_{l , l ′} {f}_{l ′} ] - {B}_{l , l ′} {f}_{l ′} = {S}_{l}$$

For example, the differential

$$\frac{\partial }{\partial ε}$$

of the carrier kinetic energy ε may be removed from [Equation 4]. According to [Equation 6] described above, a numerical analysis on the Boltzmann transport equation may be more stably performed by mainly computing a differential of the real space. However, when the potential V set for the semiconductor device model changes with time, it may be difficult to analyze the Boltzmann transport equation by using [Equation 6] described above.

Accordingly, the approximate H-transformation may be the approximate Boltzmann transport equation (e.g., [Equation 1] described above) based on the discretized total energy h, which is substituted for [Equation 6] described above. For example, [Equation 1] described above may be derived by substituting the discretized total energy h as approximated total energy for the total energy H and substituting a differential ∂/∂h of the discretized total energy h for the differential ∂/∂ε of the carrier kinetic energy ε in [Equation 4] based on [Equation 2] and [Equation 3].

According to [Equation 1] described above, even when the potential V set for the semiconductor device model changes with time, a numerical analysis on the approximate Boltzmann transport equation may be stably or more stable performed.

In operation S1300, a boundary condition of a semiconductor device operation condition is applied to a discretized time scale. Herein, the boundary condition may correspond to the preset range described above. As a potential range according to the boundary condition is narrower, the approximate Boltzmann transport equation is closer to a linear equation, and thus, the approximate Boltzmann transport equation may be analyzed better.

In operation S1400, the carrier velocity and density according to kinetic energy and the positions of carriers in the semiconductor device are computed by using the Boltzmann transport equation. Herein, the Boltzmann transport equation may be the approximate Boltzmann transport equation as in [Equation 1] described above. The carrier velocity and density may be the performance value of the semiconductor device model described above.

In operation S1500, a carrier distribution corresponding to the positions and the total energy is collected with the discretized time scale.

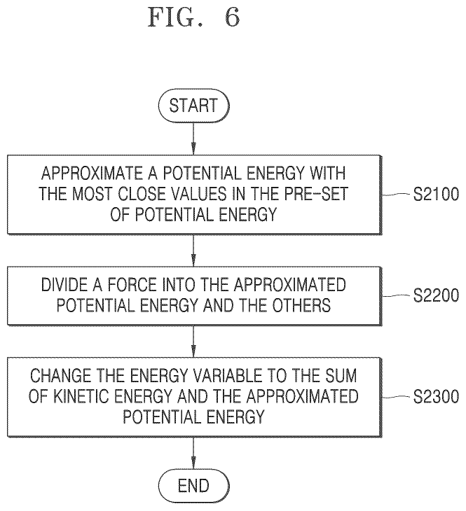

FIG. 6 is a flowchart illustrating a method of establishing an approximate Boltzmann transport equation according to some example embodiments.

Referring to FIG. 6, in operation S2100, potential energy is approximated as a value (e.g., the approximated carrier potential \tilde{V}) closest to preset potential energy (e.g., the potential V set for the semiconductor device model).

In operation S2200, a force is divided into the approximated potential energy (e.g., the approximated carrier potential \tilde{V}) and the others.

In operation S2300, an energy variable is changed to the sum of kinetic energy and the approximated potential energy (e.g., the approximated carrier potential \tilde{V}).

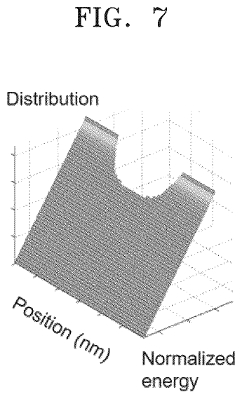

FIG. 7 is a graph illustrating a carrier distribution function distributed according to continuous total energy.

Referring to FIG. 7, on an axis indicating the distribution in the graph shown in FIG. 7, the higher the position of a gradation, the greater the value of the gradation. On an axis indicating position, as the position of a gradation is closer to the axis indicating distribution, the value of the gradation may be greater. On an axis indicating normalized energy, as the position of a gradation is closer to the axis indicating position, the value of the gradation may be greater. Herein, the normalized energy may indicate continuous total energy.

According to the H-transformation described above, the carrier distribution function shown in FIG. 7 may decrease, e.g. may exponentially decrease according to normalized continuous total energy. Alternatively or additionally, the carrier distribution function shown in FIG. 7 may be the same regardless of or independent of positions.

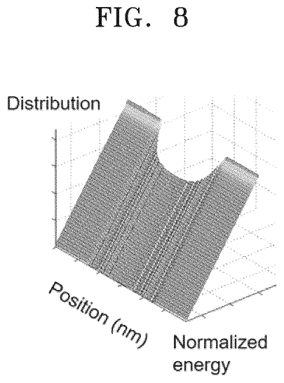

FIG. 8 is a graph illustrating a carrier distribution function distributed according to discretized total energy.

Referring to FIG. 8, on an axis indicating distribution in the graph shown in FIG. 8, the higher the position of a gradation, the greater the value of the gradation. On an axis indicating position, as the position of a gradation is closer to the axis indicating distribution, the value of the gradation may be greater. On an axis indicating normalized energy, as the position of a gradation is closer to the axis indicating position, the value of the gradation may be greater. Herein, the normalized energy may indicate discretized total energy.

According to the H-transformation described above, in the same manner as shown in FIG. 7, the carrier distribution function shown in FIG. 8 may decrease, e.g. may exponentially decrease, according to the discretized total energy. However, unlike shown in FIG. 7, a distribution of the carrier distribution function shown in FIG. 8 may vary depending on a position. Particularly, when gradations on the axis indicating position have a range between x nm and y nm (herein, x is a natural number less than y), as a gradation on the axis indicating position is closer to a mean or median value between x and y, the distribution of the carrier distribution function may be gradually less, and as a gradation on the axis indicating position is closer to x or y, the distribution of the carrier distribution function may be gradually greater and have a large or the maximum value. For example, an open form of the distribution of the carrier distribution function shown in FIG. 8 may correspond to a well shape having the least value at a median position.

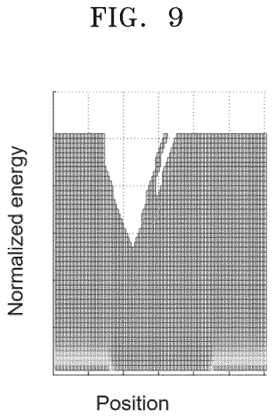

FIG. 9 is a graph illustrating a simulation result value computed based on the Boltzmann transport equation to which kinetic energy is applied.

Referring to FIG. 9, a solution of the Boltzmann transport equation to which kinetic energy is applied when a potential changes may be obtained. However, a negative carrier distribution function at a high energy band may occur. For example, on an axis indicating position, which is shown in FIG. 9, a kinetic energy of a position corresponding to a particular gradation, e.g., a gradation located in the middle of the axis, may have a negative value. In this case, like the graph shown in FIG. 9, a particular region of the graph may be empty.

As shown in FIG. 9, because both a differential of energy and a differential of a real space exist in H-transformation to which a kinetic energy-based Boltzmann transport equation is applied, when a magnitude of the force F increases, it may be difficult to stably analyze the kinetic energy-based Boltzmann transport equation. This difficulty may cause an inaccurate path along which carriers move in a designated electric field. Accordingly, a diffusion phenomenon in an energy space according to a numerical analysis error may occur. In a strong electric field, the carriers may be largely accelerated to increase a variation of kinetic energy, and accordingly, a negative carrier distribution function may occur.

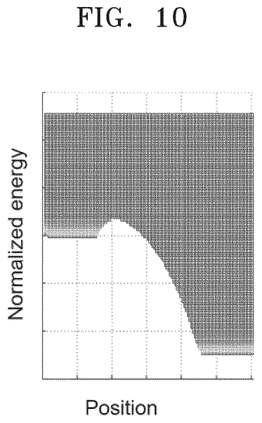

FIG. 10 is a graph illustrating a simulation result value computed based on an approximate Boltzmann transport equation to which discretized total energy is applied.

Referring to FIG. 10, a solution of the Boltzmann transport equation to which kinetic energy is applied when a potential changes may be obtained. However, unlike shown in FIG. 9, a positive carrier distribution function may occur even at a high energy band.

According to approximate H-transformation shown in FIG. 10, the stability of a numerical analysis may be largely improved by computing and processing only a differential of a real space without computing a differential of energy any more.

Some example embodiments described above may be implemented in the form of a recording medium storing instructions executable by a computer. The instructions may be stored in the form of program code, and when the instructions are executed by a processor, a program module may be generated to perform operations of the embodiments described above. The recording medium may be implemented by a computer-readable recording medium.

The computer-readable recording medium may include all types of recording media storing instructions readable by a computer. For example, the recording media may include read only memory (ROM), random access memory (RAM), a magnetic tape, a magnetic disk, flash memory, an optical data storage device, and the like.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts have been particularly shown and described with reference to some example embodiments thereof, it will be understood that various changes in form and details may be made therein without departing from the spirit and scope of the following claims. Furthermore, example embodiments are not necessarily mutually exclusive with one another. For example, some example embodiments may include one or more features described with reference to one or more figures, and may also include one or more features described with reference to one or more other figures. Still further various operations described in flow-charts may be performed or omitted, and/or may be performed in an order not necessarily described in the flow-chart, and an order of operations are not limited to those described in the various flow-charts.

1. A method, implemented on a computer, of simulating performance of a semiconductor device model, the method comprising:
establishing a carrier distribution function of the semiconductor device model, which indicates a distribution of carriers having a state of having particular energy at a particular position in a real space;
computing one or more values corresponding to a solution of an approximate Boltzmann transport equation, as [Equation 1] below, with respect to the carrier distribution function,
$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} \qquad [ Equation 1 ]$$
where l and l′ denote indexes according to a change from a momentum space to an energy space, respectively, Z_{l,l′} denotes a density of states, F denotes a force, \tilde{V} denotes an approximate carrier potential, h denotes discretized total energy, A_{l,l′} and B_{l,l′} denote coefficients for the real space and total energy, respectively, f_{l′} denotes the carrier distribution function, ∂/∂t denotes a time differential, and S denotes a scattering term related to scattering of the carriers; and
outputting a performance value of the semiconductor device model, which corresponds to the one or more values that correspond to the solution of the approximate Boltzmann transport equation, as a simulation result value.

2. The method of claim 1, wherein \tilde{V} is determined based on a value closest to a potential set for the semiconductor device model.

3. The method of claim 2, wherein \tilde{V} is determined based on a value closest to the potential set for the semiconductor device model, and is within a range.

4. The method of claim 3, wherein the range comprises discretized potentials, and \tilde{V} is determined based on a value closest to the potential set for the semiconductor device model among the discretized potentials included in the range.

5. The method of claim 4, wherein a size of the range is less than or equal to a reference size.

6. The method of claim 1, wherein the performance value of the semiconductor device model comprises a dynamic parameter indicating a characteristic transient with time.

7. The method of claim 1, wherein the performance value of the semiconductor device model comprises a static parameter indicating a characteristic independent of time.

8. The method of claim 1, wherein h denotes total energy based on [Equation 2] below,
h=ε+\tilde{V} [Equation 2]
the total energy comprising carrier kinetic energy ε and \tilde{V}.

9. The method of claim 8, wherein F denotes an electric force with respect to a potential set for the semiconductor device model based on [Equation 3] below,
F=−Δ·V [Equation 3]
where V denotes the potential set for the semiconductor device model.

10. The method of claim 1, wherein A_{l,l′} and B_{l,l′} variably change according to the real space and the total energy, respectively.

11. A device comprising:
a memory configured to store code data indicating an approximate Boltzmann transport equation and characteristics data indicating characteristics of a semiconductor device model; and
a processor configured to execute machine-readable instructions that, when executed by the processor, cause the processor to simulate performance of the semiconductor device model, based on the code data and the characteristic data, and output a performance value of the semiconductor device model as a simulation result value,
wherein the processor is further configured to establish a carrier distribution function of the semiconductor device model, which indicates a distribution of carriers having a state of having particular energy at a particular position in a real space, to compute one or more values corresponding to a solution of an approximate Boltzmann transport equation, as [Equation 1] below, with respect to the carrier distribution function,
$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} \qquad [ Equation 1 ]$$
where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for the real space and total energy, f_{l′} denotes the carrier distribution function, ∂/∂t denotes a time differential, and S denotes a scattering term related to scattering of the carriers, and to process the performance value of the semiconductor device model, based on the one or more values that corresponds to the solution of the approximate Boltzmann transport equation.

12. The device of claim 11, wherein \tilde{V} is determined based on a value closest to a potential set for the semiconductor device model.

13. The device of claim 12, wherein \tilde{V} is determined based on a value closest to the potential set for the semiconductor device model among potentials included in a range.

14. The device of claim 13, wherein the preset range comprises discretized potentials, and \tilde{V} is determined based on a value closest to the potential set for the semiconductor device model among the discretized potentials included in the range.

15. The device of claim 11, wherein the performance value of the semiconductor device model comprises a dynamic parameter indicating a characteristic transient with time.

16. The device of claim 11, wherein the performance value of the semiconductor device model comprises a static parameter indicating a characteristic independent of time.

17. The device of claim 11, wherein h denotes total energy based on [Equation 2] below,
h=ε+\tilde{V} [Equation 2]
the total energy comprising carrier kinetic energy ε and \tilde{V}.

18. The device of claim 17, wherein F denotes an electric force with respect to a potential set for the semiconductor device model based on [Equation 3] below,
F=−Δ·V [Equation 3]
where V denotes the potential set for the semiconductor device model.

19. The device of claim 11, wherein A_{l,l′} and B_{l,l′} variably change according to the real space and the total energy.

20. (canceled)

21. A system comprising:
a semiconductor device;
a measurement device configured to measure characteristics of the semiconductor device; and
a simulation device comprising a processor configured to execute machine-readable instructions that, when executed by the processor, cause the simulation device to simulate performance of a semiconductor device model corresponding to the semiconductor device, wherein the processor included in the simulation device is further configured to compute one or more values corresponding to a solution of an approximate Boltzmann transport equation, based on code data indicating the approximate Boltzmann transport equation and on characteristics data indicating characteristics of a semiconductor device model, generate a performance value of the semiconductor device model, which corresponds to the one or more values that is based on the solution of the approximate Boltzmann transport equation, as a simulation result value, and output an evaluation value obtained by evaluating the performance of the semiconductor device, based on the simulation result value and a measurement value provided from the measurement device, and
the approximate Boltzmann transport equation is [Equation 1] below,
$${\sum }_{l ′} \frac{\partial }{\partial t} [ {Z}_{l , {l}^{′}} {f}_{{l}^{′}} ] + ( F + ∇ \tilde{V} ) \cdot \frac{\partial }{\partial h} [ {A}_{l , l ′} {f}_{l ′} ] + ∇ \cdot [ {A}_{l , l ′} {f}_{l ′} ] - {B}_{l , l ′} {f}_{l ′} = {S}_{l} \qquad [ Equation 1 ]$$
where l and l′ denote indexes according to a change from a momentum space to an energy space, Z_{l,l′} denotes a density of states, F denotes a force, \tilde{V} denotes an approximate carrier potential, h denotes discretized total energy, A_{l,l′} and B_{l,l′} denote coefficients for a real space and total energy, f_{l′} denotes a carrier distribution function indicating a distribution of carriers having a state of having particular energy at a particular position in the real space, ∂/∂t denotes a time differential, and S denotes a scattering term related to scattering of the carriers.

22-30. (canceled)
